(19) United States
(12) Patent Application Publication
(10) Pub. No.: US 2026/0109096 A1
(43) Pub. Date: Apr. 23, 2026

(54) INFORMATION PROCESSING APPARATUS, INJECTION MOLDING MACHINE, INFORMATION PROCESSING METHOD AND NON-TRANSITORY COMPUTER READABLE RECORDING MEDIUM

(71) Applicant: THE JAPAN STEEL WORKS, LTD., Tokyo (JP)

(72) Inventor: Syunsuke TAKAMATSU, Tokyo (JP)

(21) Appl. No.: 19/360,064

(22) Filed: Oct. 16, 2025

(30) Foreign Application Priority Data
Oct. 18, 2024 (JP) 2024-184190

(51) Int. Cl. B29C 45/76

(52) U.S. Cl. CPC B29C 45/768; B29C 2945/76949

(57) ABSTRACT

Provided is an information processing apparatus and the like that can create inspection data regarding a failure in an injection molding machine with sufficient accuracy and uniformity, and notify the inspection data in the case where trouble occurs in the injection molding machine. An information processing apparatus comprises a processing unit configured to acquire testification data related to a failure of the injection molding machine through a dialog with a user using a chatbot and machine log data of the injection molding machine in a case where trouble occurs in the injection molding machine; and create investigation data including the acquired testification data and machine log data, and a communication unit configured to upload the created investigation data to an external database or notifying a person involved in the injection molding machine of the investigation data.

### REFERENCE TO RELATED APPLICATIONS

This application claims priority from Japanese Patent Application No. 2024-184190 filed on Oct. 18, 2024. The entire content of the priority application is incorporated herein by reference.

### FIELD

The present disclosure relates to an information processing apparatus, an injection molding machine, an information processing method and a computer program.

### BACKGROUND ART

Japanese Patent Application Laid-Open Publication No. 2011-083958 discloses an injection molding machine configured to, in the case where a failure occurs in the injection molding machine, store data necessary for diagnosing the failure in a controller internal memory and to externally read the data.

In the case where trouble occurs in the injection molding machine, the following measures are specifically taken. The user contacts a serviceperson, and the serviceperson who receives the contact is sent to grasp the current situation and restores the trouble on the same day if the trouble can be solved on the spot. The serviceperson fills out a report and transmits the report to the manufacturer.

### SUMMARY

Creating reports is, however, a burden on the servicepersons, and accurate information cannot sometimes be obtained from the user, or the accuracy of reports may vary depending on the skill and workload of the servicepersons. Variations in the accuracy of reports cause delays in the restoration of machines, which leads to a decrease in user satisfaction with the service response.

An object of the present disclosure is to provide an information processing apparatus and the like that can create inspection data regarding a failure in the injection molding machine with sufficient accuracy and uniformity, and notify the inspection data in the case where trouble occurs in the injection molding machine.

### Solution to Problems

An information processing apparatus according to one aspect of the present disclosure is an information processing apparatus comprising a processing unit configured to acquire testification data related to a failure of an injection molding machine through a dialog with a user using a chatbot and machine log data of the injection molding machine in a case where trouble occurs in the injection molding machine; and create investigation data including the acquired testification data and machine log data, and a communication unit configured to upload the created investigation data to an external database or notifying a person involved in the injection molding machine of the investigation data.

An injection molding machine according one aspect of the present disclosure is an injection molding machine comprising a processing unit configured to acquire testification data related to a failure of the injection molding machine through a dialog with a user using a chatbot and machine log data of the injection molding machine in a case where trouble occurs in the injection molding machine; and create investigation data including the acquired testification data and machine log data, and a communication unit configured to upload the created investigation data to an external database or notifying a person involved in the injection molding machine of the investigation data.

An information processing method according to one aspect of the present disclosure comprises: acquiring testification data related to a failure of an injection molding machine through a dialog with a user using a chatbot and machine log data of the injection molding machine in a case where trouble occurs in the injection molding machine; and creating investigation data including the acquired testification data and machine log data, and uploading the created investigation data to an external database or notifying a person involved in the injection molding machine of the investigation data.

A computer program according to one aspect of the present disclosure causing a computer to execute processing of: acquiring testification data related to a failure of an injection molding machine through a dialog with a user using a chatbot and machine log data of the injection molding machine in a case where trouble occurs in the injection molding machine; creating investigation data including the acquired testification data and machine log data; and uploading the created investigation data to an external database or notifying a person involved in the injection molding machine of the investigation data.

According to the present disclosure, it is possible to provide an information processing apparatus and the like that can create inspection data regarding a failure in the injection molding machine with sufficient accuracy and uniformity, and can notify the inspection data in the case where trouble occurs in the injection molding machine.

The above and further objects and features will more fully be apparent from the following detailed description with accompanying drawings.

### BRIEF DESCRIPTION OF DRAWINGS

FIG. 1 is a block diagram depicting an example of the configuration of an injection molding machine system according to Embodiment 1.

FIG. 2 is a block diagram illustrating an example of the configuration of a control device according to Embodiment 1.

FIG. 3 is a block diagram illustrating an example of the configuration of an information processing apparatus according to Embodiment 1.

FIG. 4 is a conceptual diagram depicting an example of the configuration of a user machine DB.

FIG. 5 is a flowchart depicting a report creation processing procedure according to Embodiment 1.

FIG. 6 is a conceptual diagram illustrating a report creation processing method according Embodiment 1.

FIG. 7 is a schematic diagram depicting an example of a report.

FIG. 8 is a schematic diagram depicting the configuration of situation details to be input to the report.

FIG. 9 is a block diagram depicting an example of the configuration of an injection molding machine system according to Embodiment 2.

FIG. 10 is a flowchart depicting a report creation processing procedure according to Embodiment 3.

### DESCRIPTION

An information processing apparatus, an injection molding machine, an information processing method and a computer program according to embodiments of the present disclosure will be described below with reference to the drawings. It should be noted that the present disclosure is not limited to these examples, but is indicated by the scope of claims, and is intended to include all modifications within the meaning and scope equivalent to the scope of claims. Furthermore, at least parts of the following embodiments may arbitrarily be combined.

### Embodiment 1

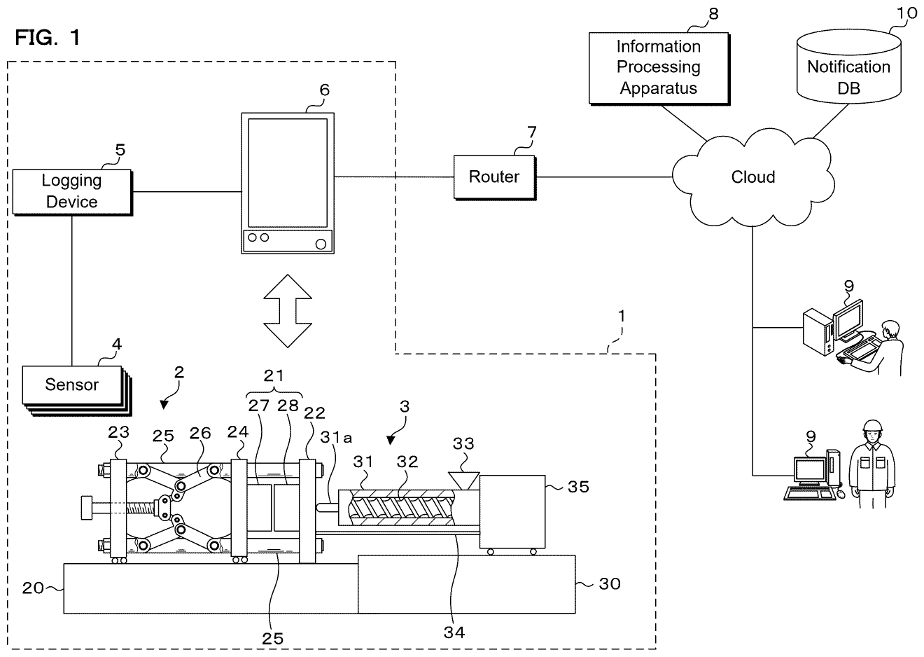

FIG. 1 is a block diagram depicting an example of the configuration of an injection molding machine system according to Embodiment 1. The injection molding machine system includes an injection molding machine 1, a router 7, an information processing apparatus 8, a communication terminal 9 and a notification DB 10.

The communication terminal 9 corresponds to communication equipment with a display portion, such as a computer, a tablet terminal or a smartphone. The communication terminal 9 is a terminal used by a person involved in the injection molding machine 1. The terminals used by the persons involved in the injection molding machine include terminals for maintenance and inspection persons of the injection molding machine 1, terminals for servicepersons, terminals for sales offices in charge of the injection molding machine 1 and terminals for quality assurance departments.

The notification DB 10 is a database for notifying report data summarizing a failure situation of the injection molding machine 1 to the communication terminal 9 from the information processing apparatus 8. The information processing apparatus 8 can store the report data in the notification DB 10. The communication terminal 9 can read and display the report data stored in the notification DB10 and edit the details of the report data.

### Injection Molding Machine 1

The injection molding machine 1 includes a mold clamping device 2 for clamping a metal mold 21, an injection device 3 for plasticizing and injecting molding material, multiple sensors 4, a logging device 5 and a control device 6.

The mold clamping device 2 is provided with a fixed platen 22 fixed on a bed 20, a mold clamping housing 23 slidably provided over the bed 20 and a movable platen 24 that similarly slides over the bed 20. The fixed platen 22 and the mold clamping housing 23 are coupled with multiple, for example, four tie-bars 25, 25 . . . . The movable platen 24 is configured to be slidable between the fixed platen 22 and the mold clamping housing 23. Between the mold clamping housing 23 and the movable platen 24, a mold clamping mechanism 26 is provided. The mold clamping mechanism 26 is constructed by a toggle mechanism, for example. Note that the mold clamping mechanism 26 may be composed of a direct pressure mold clamping mechanism, that is, a mold clamping cylinder. The fixed platen 22 and the movable platen 24 are respectively provided with a fixed mold 28 and a movable mold 27, and the metal mold 21 is configured to be opened and closed when the clamping mechanism 26 is driven.

The mold clamping device 2 is further provided with an ejector pin for taking out a molded product from the metal mold 21 and a drive motor for driving the ejector pin.

The injection device 3 is provided on a base 30. The injection device 3 includes a heating cylinder 31 having a nozzle 31a at the tip and a screw 32 provided inside the heating cylinder 31 so as to be rotatably disposed in a circumferential direction and an axial direction. Inside or at the outer circumference of the heating cylinder 31, a heater for melting a molding material is provided. The screw 32 is driven in rotational and axial directions by a drive device 35.

Near the rear of the heating cylinder 31, a hopper 33 for inputting molding materials is provided. The injection molding machine 1 is provided with a nozzle touch device 34 that moves the injection device 3 in the front-back direction (left-right direction in FIG. 1). When the nozzle touch device 34 is driven, the injection device 3 is configured to move forward so that the nozzle 31a of the heating cylinder 31 touches a contact portion of the fixed platen 22.

The multiple sensors 4 are elements and circuits that detect physical quantities related to the condition of the injection molding machine 1 or the quality of a molded product. In other words, the multiple sensors 4 are elements and circuits that detect time-series physical quantities related to the operation of the injection molding machine 1 obtained during the injection molding process of a molded product using the injection molding machine 1.

The sensors 4 include sensors provided on the injection molding machine 1 as requisites for controlling the operation of the injection molding machine 1 and sensors separately provided for inferring the condition of the injection molding machine 1. All or a part of the multiple sensors 4 are connected to the logging device 5, so that the sensors 4 output signals indicating the detected physical quantities to the logging device 5. The information processing apparatus 8 to be described later acquires physical quantity data from the sensors 4 via the logging device 5. The physical quantity data is data of time-series sensor values indicating the detected physical quantities.

A part of the multiple sensors 4 are connected to the control device 6, so that the information processing apparatus 8 can also acquire physical quantity data from the sensors 4 via the control device 6.

The physical quantities include temperature, position, velocity, acceleration, current, voltage, pressure, time, image data, torque, force, distortion, power consumption, weight and the like. These physical quantities can be measured with a thermometer, a position sensor, a speed sensor, an accelerometer, an ammeter, a voltmeter, a pressure gauge, a timer, a camera, a torque sensor, a wattmeter, a weightometer and the like.

The multiple sensors 4 include, for example, a speed sensor for detecting speed of the screw 32, a speed sensor for detecting speed of the movable platen 24 and a speed sensor for detecting speed of an ejector pin.

The multiple sensors 4 include, for example, a torque sensor for detecting torque of a motor driving the screw 32, a torque sensor for detecting torque of a motor driving the movable platen 24 and a torque sensor for detecting torque of a motor driving the ejector pin.

The multiple sensors 4 include, for example, a pressure sensor for detecting pressure inside the screw 32 or the heating cylinder 31 and a pressure sensor for detecting pressure applied to the metal mold 21.

The multiple sensors 4 include a load cell detecting pressure longitudinally applied to the screw 32.

The multiple sensors 4 include, for example, a position sensor for detecting a position of the screw 32, a position sensor for detecting a position of the movable platen 24 and a position sensor for detecting a position of the ejector pin.

The multiple sensors 4 include, for example, a tachometer for detecting rotational speed of the motor driving the screw 32, a tachometer for detecting rotational speed of the motor driving the movable platen 24, and a tachometer for detecting rotational speed of the motor driving the ejector pin.

The multiple sensors 4 include a load sensor for detecting a clamping force caused by the clamping device 2.

The multiple sensors 4 include a thermometer for detecting a temperature of the hopper 33, a thermometer for detecting temperatures at one or more locations in the cylinder 31, and a thermometer for detecting temperatures at one or more locations in the nozzle 31a.

The sensors 4 also include any other detectors capable of detecting physical quantities that contribute to the estimation of the quality of a molded product.

The logging device 5 is a Programmable Logic Controller (PLC), for example. The logging device 5 samples analog signals output from the multiple sensors 4 at a predetermined period to perform AD conversion and stores the converted signals as physical quantity data indicating the time-series physical quantities in the internal memory. The logging device 5 further samples a signal of a command value output from the control device 6 at a predetermined period to perform AD conversion and stores the converted signal as time-series command value data in the internal memory. The logging device 5 stores the physical quantity data and the command value data in a CSV file form, for example. The logging device 5 transfers a file of the logged physical quantity data and command value data to the control device 6 for each cycle of the injection molding. The physical quantity data is data, which is obtained during the injection molding process of a molded product using the injection molding machine 1, and is related to the presence or absence of an abnormality in the injection molding machine 1 and the cause of the abnormality.

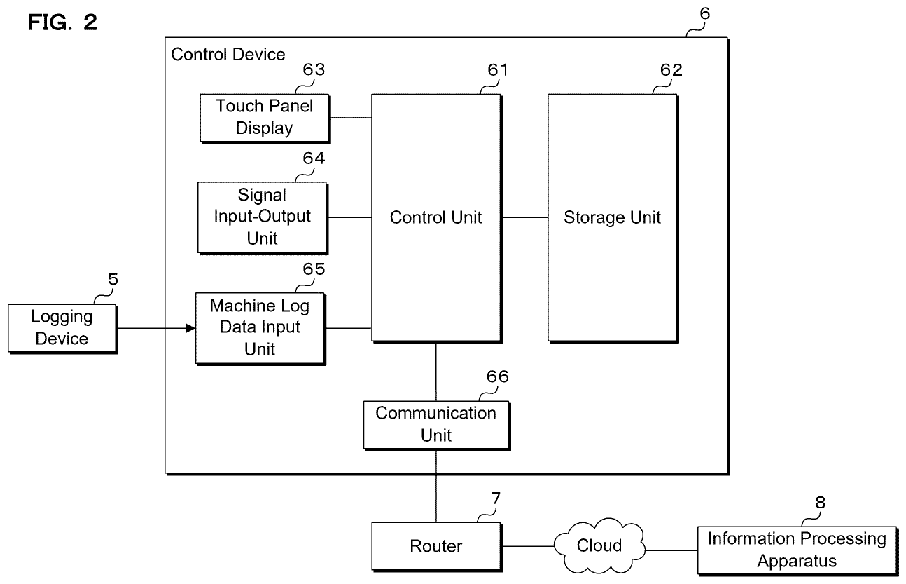

FIG. 2 is a block diagram illustrating an example of the configuration of the control device 6 according to Embodiment 1. The control device 6, which is a computer that controls the operation of the injection molding machine 1, is provided with a control unit 61, a storage unit 62, a touch panel display 63, a signal input-output unit 64, a machine log data input unit 65 and a communication unit 66. The user can set a molding condition (operating condition) for operating the injection molding machine 1 by operating the touch panel display 63. The molding condition includes, for example, multiple settings such as a hopper temperature, cylinder temperatures at several locations and a nozzle temperature, multiple injection speeds changed at multi stages, holding pressure, holding time and the like. The control device 6 outputs an instruction signal to the injection molding machine 1 based on various setting values indicated by the molding condition and detection values from the sensors 4 provided in the control device 2 or the injection device 3 to operate the injection molding machine 1. In addition, the control device 6 acquires physical quantity data from the sensors 4 and monitors trouble in the injection molding machine 1 based on the acquired physical quantity data. In the case where trouble occurs in the injection molding machine 1, data indicative of occurrence of trouble is transmitted to the information processing apparatus 8. Note that the processing of monitoring trouble in the injection molding machine 1 may be executed by a separate failure monitoring device.

The control unit 61 is a processor and includes an arithmetic processing circuit such as a CPU (Central Processing Unit), a multi-core CPU, an Application Specific Integrated Circuit (ASIC) or a Field-Programmable Gate Array (FPGA), an internal storage device such as a ROM (Read Only Memory) or a RAM (Random Access Memory), and an I/O terminal. The control unit 61 functions as the control device 6 by executing a control program stored in the storage unit 62.

The control unit 61 displays a status of the injection molding machine 1 on the touch panel display 63 and controls the operation of each component part of the injection molding machine 1 according to an operation performed on the touch panel display 63. The control unit 61 further executes the processing of managing the permission for setting change operation for the molding condition in the injection molding machine 1 and limiting the setting change operation depending on an operation permission level of the user. The control unit 61 also executes processing related to editing of the operation permission level of the user and editing of the limit range of the setting change operation. Note that each functional part of the control device 6 may be realized in software or in hardware, or in combination thereof.

The storage unit 62 has a nonvolatile memory such as a hard disk, a flash memory, an SSD (Solid State Drive) or the like. The storage unit 62 stores a control program, other various programs and data that are to be referred to by the control unit 61.

The touch panel display 63 is provided with a display panel and a touch sensor. The display panel has a display device such as, for example, a liquid crystal display or an organic EL (Electro Luminescence) display. The touch panel display 63 displays, for example, an operation screen necessary for setting and operation of a molding condition of the injection molding machine 1, a status screen for displaying an operation status of the injection molding machine 1, according to an instruction from the control unit 61. In addition, the touch panel display 63 displays a chat screen for accepting user testification data related to failure in the injection molding machine 1 when trouble occurs in the injection molding machine 1. The touch sensor is a display built-in touch panel device, for example, and accepts various input operations by the user. The touch sensor further accepts an operation input from the user and sends an instruction signal according to the operation details to the control unit 61.

Though the touch panel display 63 is herein employed for the operation means by the user via the control device by way of example, it may be composed of well-known display device and input device. The display device is a display device such as a liquid crystal display or an organic EL (Electro Luminescence) display. The input device includes hardware keys such as keyboards and a device such as a mouse.

The signal input-output unit 64 is provided with a signal input terminal for receiving a signal of measured values output from the sensors 4 provided in the injection molding machine 1 and a signal output terminal for outputting an instruction signal to control the operation of the mold clamping device 2 or the injection device 3 according to a control by the control unit 61 to the driving unit of the mold clamping device 2 or the injection device 3.

The machine log data input unit 65 is an input interface to which signals output from the sensors 4 are input. The machine log data input unit 65 is connected to the sensors 4, so that the control unit 61 can acquire machine log data via the machine log data input unit 65.

The communication unit 66 is a communication circuit that transmits and receives information according to a predetermined communication protocol such as the Ethernet (registered trademark) or the like. The communication unit 66 is connected to the information processing apparatus 8 on a cloud via a router 7, so that the control unit 61 can transmit and receive various information to and from the information processing apparatus 8 via the communication unit 66.

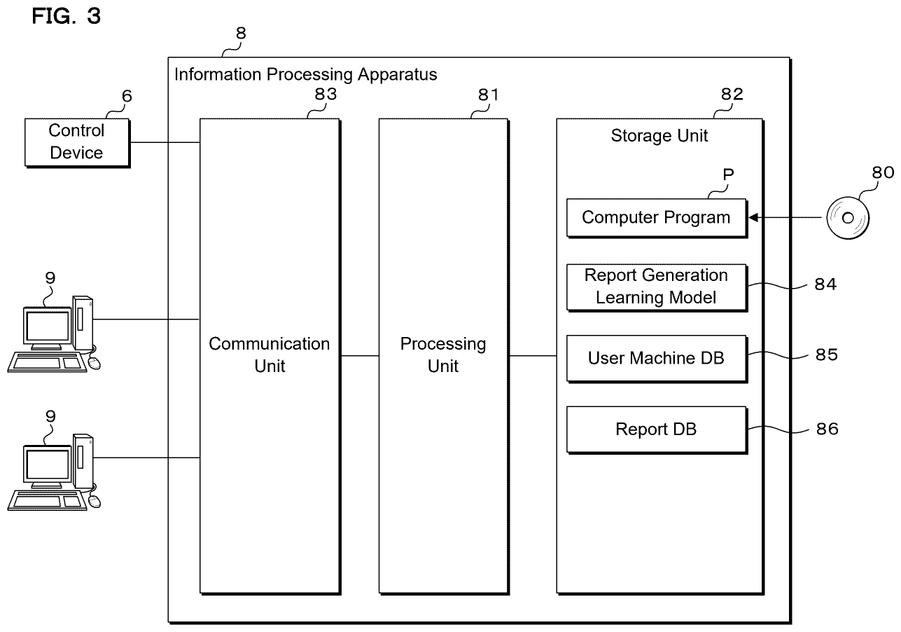

FIG. 3 is a block diagram illustrating an example of the configuration of the information processing apparatus 8 according to Embodiment 1. The information processing apparatus 8, which is a computer, is provided with a processing unit 81, a storage unit 82 and a communication unit 83. The storage unit 82 and the communication unit 83 are connected to the processing unit 81.

The processing unit 81, which is a processor, includes an arithmetic processing circuit such as a CPU, a multi-core CPU, a GPU (Graphics Processing Unit), a General-Purpose Computing on Graphics Processing Units (GPGPU), a Tensor Processing Unit (TPU), an ASIC, an FPGA or a Neural Processing Unit (NPU), an internal storage such as a ROM or a RAM, and an I/O terminal. The processing unit 81 functions as the information processing apparatus 8 according to the present embodiment by executing a computer program P stored in the storage unit 82, which will be described later. Note that each functional part of the the information processing apparatus 8 may be realized in software, or a part or all of the functional parts may be realized in hardware.

The communication unit 83 is a communication circuit that transmits and receives information according to a predetermined communication protocol such as the Ethernet (registered trademark). The communication unit 83 is connected to the control device 6 and the communication terminal 9 over a communication network, so that the processing unit 81 can transmit and receive various information to and from the control device 6 and the communication terminal 9 via the communication unit 83.

The storage unit 82 is a nonvolatile memory such as a hard disk, an EEPROM or a flash memory. The storage unit 82 stores a computer program P for causing a computer to implement the processing of collecting testification data, machine log data and the like related to a failure of the injection molding machine 1 when trouble occurs in the injection molding machine 1 and creating report data including various failure-related data filled out, as well as a report generation learning model 84, a user machine DB 85 and a report DB 86.

The computer program P and the like may be recorded on a recording medium 80 so as to be readable by the computer. The storage unit 82 stores the computer program P and the like read from the recording medium 80 by a reader (not illustrated). The recording medium 80 is a semiconductor memory such as a flash memory. The recording medium 80 may be an optical disc such as a CD (Compact Disc)-ROM, a DVD (Digital Versatile Disc)-ROM, or a BD (Blu-ray (registered trademark)) Disc. Moreover, the recording medium 80 may be a magnetic disk such as a flexible disk or a hard disk, or a magneto-optical disk. In addition, the computer program P and the like may be downloaded from an external server (not illustrated) connected to a communication network (not illustrated) and may be stored in the storage unit 82.

The report generation learning model 84 is, for example, a Large Language Model (LLM). The large language model is a machine learning model using a mechanism called Transformer, for example. The large language model according to Embodiment 1 is a model that outputs report data in a predetermined format in which information related to a failure of the injection molding machine 1 is organized if receiving an input of a prompt that is created based on testification data collected from the user when trouble occurs in the injection molding machine 1, machine log data collected from the injection molding machine 1 and user machine data read from the user machine DB 85.

Large-scale language models may include a general-purpose LLM, or a model that is fine-tuned to output accurate advice as to whether the transaction journal information is for business use or personal use.

In addition, the information processing apparatus 8 may be configured to access an LLM server (not illustrated) that provides an API (Application Programming Interface) related to the large-scale language model, which is the report generation learning model 84, to utilize a service with the report generation learning model 84 by the LLM serve through the API.

While the large language model is described as one example of the report generation learning model 84, the types of models are not particularly limited as long as they can execute natural language processing of performing processing of text data such as input testification data, machine log data and user machine data and outputting a desired result.

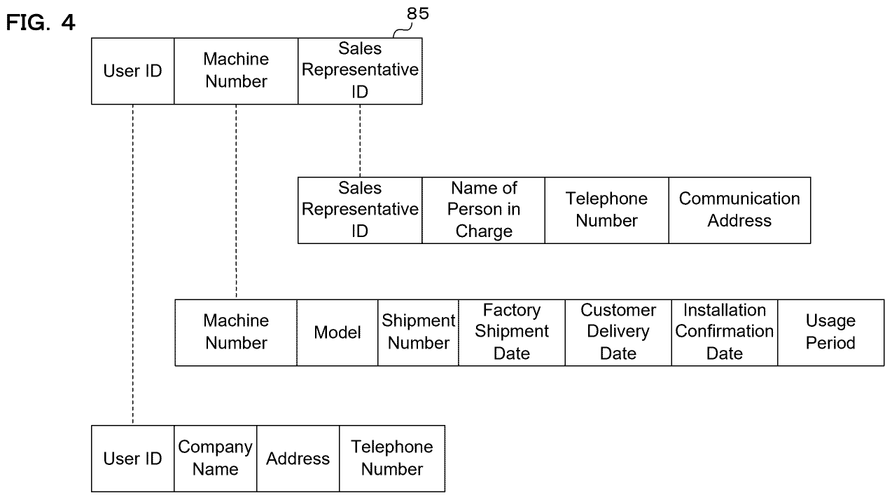

FIG. 4 is a conceptual diagram depicting an example of the configuration of the user machine DB 85. The user machine DB 85 is database for storing basic information of the user of the injection molding machine 1, sales representative information of the injection molding machine 1, machine information of the injection molding machine 1 and the like. For example, the user machine DB 85 stores user IDs, machine numbers and sales representative IDs in association with each other. The company name, address, telephone number and the like of the user of the injection molding machine 1 are associated with the user ID and stored in the user machine DB 85. The model, shipment number, factory shipment date, customer delivery date, installation confirmation date, usage period and the like of the injection molding machine 1 are associated with the machine number and stored in the user machine DB 85. The name, telephone number, communication address and the like of the person in charge of maintenance and inspection as well as various sales services of the injection molding machine 1 are associated with the sales representative ID and stored in the user machine DB 85. The communication address is an e-mail address of a communication terminal used by the sales representative, for example.

The report DB 86 is a database for storing report data created by the information processing apparatus 8. The report data is stored in association with a machine number, for example, in the report DB 86.

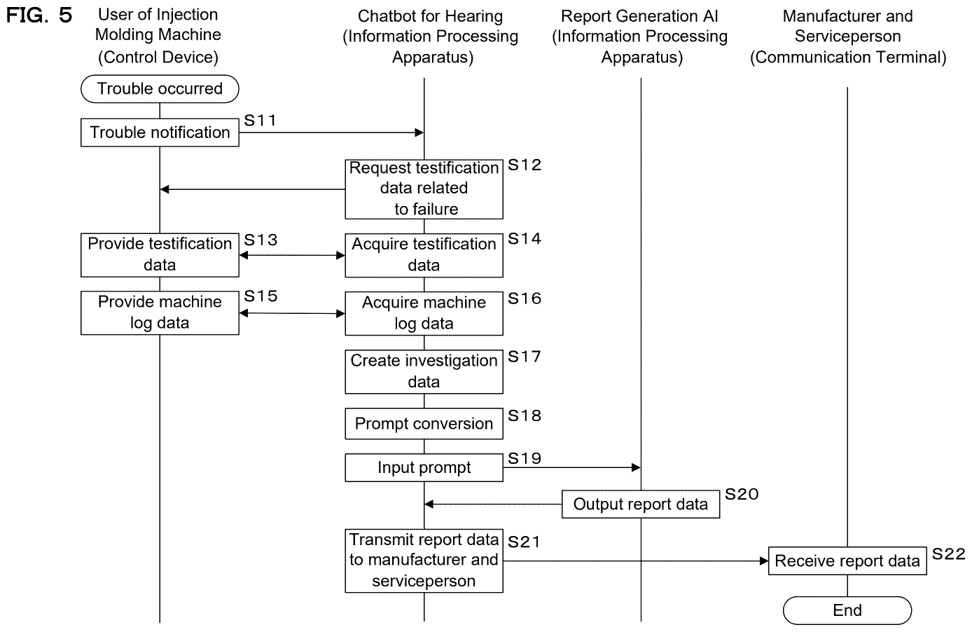

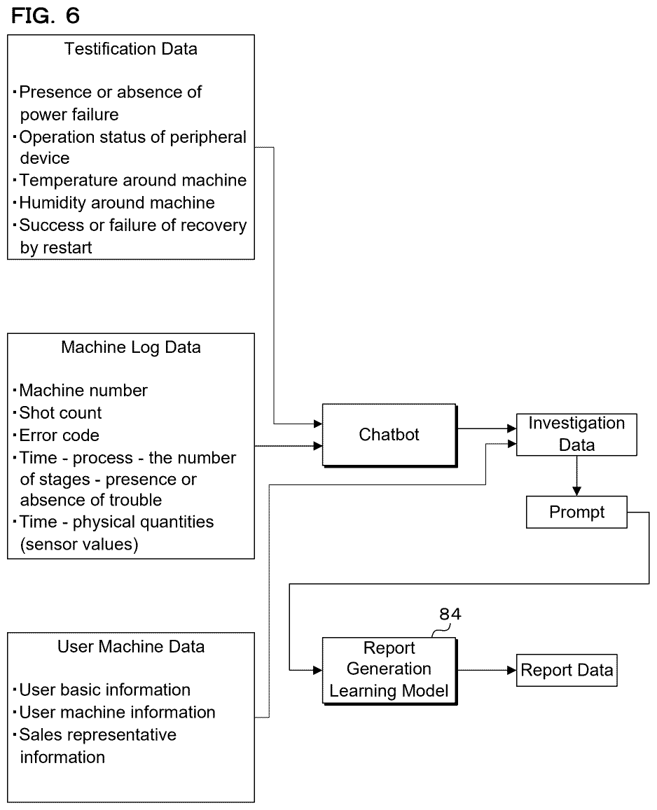

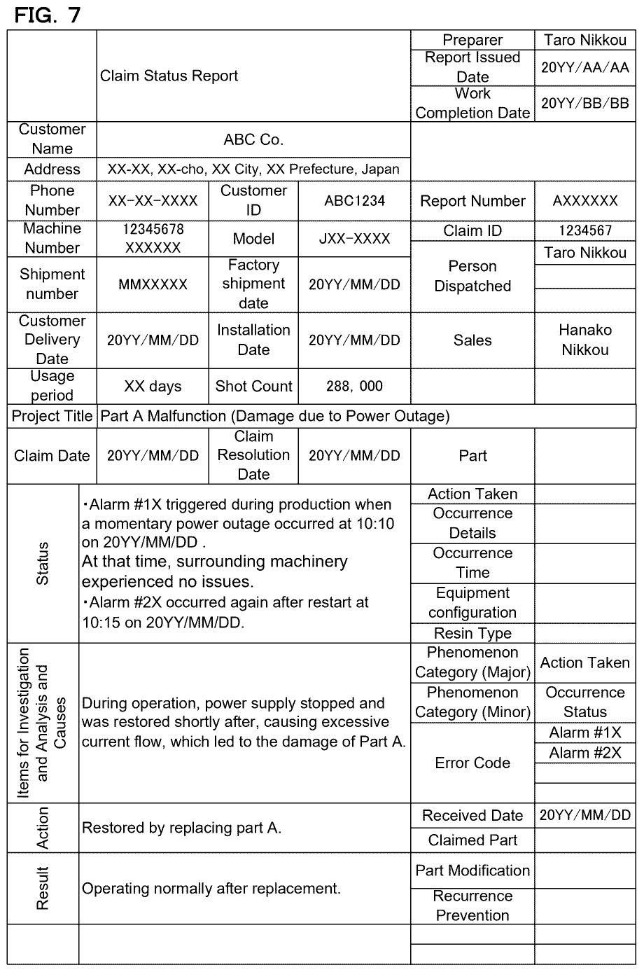

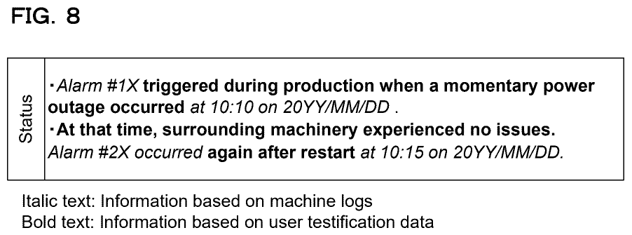

FIG. 5 is a flowchart depicting a report creation processing procedure according to Embodiment 1. FIG. 6 is a conceptual diagram illustrating a report creation processing method according Embodiment 1. FIG. 7 is a schematic diagram depicting an example of the report. FIG. 8 is a schematic diagram depicting the configuration of situation details to be input to the report.

The control device 6 of the injection molding machine 1 transmits, in the case where trouble occurs in the injection molding machine 1, a notification indicative of occurrence of the trouble to the information processing apparatus 8 (step S11). The processing unit 81 of the information processing apparatus 8 having received the trouble notification transmitted from the injection molding machine 1 requests the control device 6 of the injection molding machine 1 to send the testification data and machine log data related to the failure of the injection molding machine 1 (step S12).

The information processing apparatus 8 executes processing of acquiring machine log data of the injection molding machine 1 and testification data related to the failure of the injection molding machine 1 through dialog using a chatbot between the user and the control device 6 having received the request for testification data.

Specifically, the processing unit 81 transmits question data asking about the information related to the failure of the injection molding machine 1 to the control device 6, and the control device 6 displays the question. The user can input an answer to the question using the touch panel display 63. The control device 6 provides the information processing apparatus 8 with the input answer as testification data (step S13). The processing unit 81 of the information processing apparatus 8 acquires the testification data provided from the control device 6 (step S14). The information processing apparatus 8 and the control device 6 repeatedly execute various questions and answers to collect information related to the failure of the injection molding machine 1. As illustrated in FIG. 6, for example, the information processing apparatus 8 can acquire testification data including the presence or absence of power failure, the operation status of peripheral devices, the temperature around the machine, the humidity around the machine and the success or failure of recovery by a restart when trouble occurs in the injection molding machine 1.

Note that the dialog processing performed between the information processing apparatus 8 and the control device 6 is rule-based processing. The dialog performed between the information processing apparatus 8 and the control device 6 may be typical question and answer or may be changed depending on the details of the user basic information and user machine information stored in the user machine DB 85. In addition, the details of the question may be changed according to the user's answer.

If the details of the dialog are complex, the information processing apparatus 8 may be configured to execute dialog processing using a machine learning model such as a large-scale language model or the like and acquire testification data.

On the other hand, in response to the request for the machine log data, the control device 6 provides the information processing apparatus 8 with the machine log data collected before and after the occurrence of trouble (step S15). The processing unit 81 of the information processing apparatus 8 acquires the machine log data provided from the control device 6 (step S16). As illustrated in FIG. 6, the machine log data includes, for example, a machine number, the number of shots and an error code as basic information. The machine log data includes time series log data in which the time, the number of processes and stages of injection molding as well as the presence or absence of trouble at the time are associated with each other.

One process may include multiple stages. For example, the injection process may include different injection speeds of an injection process at a first stage and an injection process at a second stage. Here, the machine log data includes not only the process in the injection process but also the stage in the process. Containing data indicating the process itself and the stage in the machine log data can provide more accurate log data.

Note that the data indicative of the presence or absence of trouble may be error code data. In addition, the machine log data includes log data in which the physical quantities (sensor values) obtained by the sensors 4 are associated with the time.

Next, the processing unit 81 of the information processing apparatus 8 creates investigation data in which the testification data and machine log data obtained by the processing at steps S14 to S16 (step S17) are employed and merged based on each data. Using the machine number included in the machine log data as a key, the user basic information, user machine information, sales representative information and the like are read from the user machine DB 85, and these read information as well as the testification data and machine log data may be employed and merged to create investigation data.

The processing unit 81 then converts the created investigation data into a prompt, which is a directive to the report generation learning model 84 (step S18).

The prompt is, for example, texts containing a report creation directive, testification data, machine log data and user machine data. Specifically, the prompt is text as follows:
Role: You are a technical expert who analyzes machine trouble occurring in the injection molding machine 1.
Task: Write the report data in a predetermined format from Information 1, Information 2 and Information 3 below.

1Information 1: Testification data
Information 2: Machine log data
Information 3: User machine data

The processing unit 81 of the information processing apparatus 8 then inputs the prompt having undergone the conversion processing at step S18 to the report generation learning model 84 (step S19), to generate and output report data (step S20).

The processing unit 81 transmits the report data generated by the processing at steps S19 and S20 to the communication terminals 9 of various servicepersons and other involved persons of the injection molding machines 1 (step S21). The communication terminal 9 receives the report data transmitted from the information processing apparatus 8 (step S22) and ends the processing. With reference to the user machine DB 85 using the machine number included in the machine log data as a key, the processing unit 81 can specify the communication address of the sales representative that is associated with the machine number of the injection molding machine 1 in which trouble has occurred, that is, the communication terminal 9 to which the report data is to be transmitted.

The person in charge of maintenance and inspection as well as various servicepersons in sales offices and in the quality assurance department who carry the communication terminal 9 can check the details of the report data using the communication terminal 9. Specifically, the communication terminal 9 displays a report image illustrated in FIG. 7 based on the report data. The report image includes the basic information on the user and the injection molding machine 1, information on the situation surrounding the injection molding machine 1 obtained from the testification data, time when trouble occurred, machine log data before and after the occurrence of trouble and error code. Especially, in the “situation” field, text representing the situation of a failure of the injection molding machine 1, in which the information based on the testification data and the information based on the machine log data are merged, is input as shown in FIG. 8. The serviceperson can precisely grasp the trouble and the failure situation for the injection molding machine 1 and take a required measure by checking the report.

As described above, the injection molding machine system according to Embodiment 1 can create report data regarding a failure in the injection molding machine 1 with sufficient accuracy and uniformity, if trouble occurs in the injection molding machine 1 and notify the serviceperson of the report data.

Specifically, the information processing apparatus 8 according to Embodiment 1 utilizes a chatbot to hear the user about machine trouble and can generate a prompt in a predetermined format in which user testification and machine log data are combined. In addition, the data is input to the report generation learning model 84 to thereby create a report in a predetermined format, which allows manufacturers and servicepersons to promptly share accurate information.

While FIG. 5 depicts an example of the processing of the information processing apparatus 8 transmitting report data to the communication terminal 9, the processing unit 81 may notify the serviceperson of the report data by uploading the report data to the notification DB10.

### Embodiment 2

An injection molding machine system according to Embodiment 2 is different from that in Embodiment 1 in that the control device 6 of the injection molding machine 1 is offline. Since the other configurations of the injection molding machine system are similar to those of the system according to Embodiment 1, corresponding parts are designated by similar reference codes and detailed description thereof will not be made.

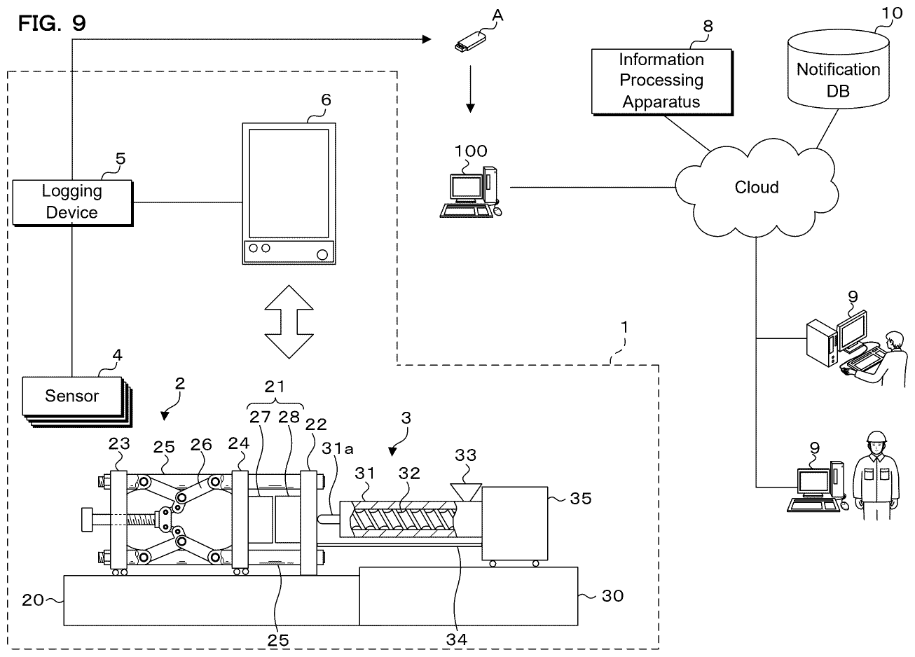

FIG. 9 is a block diagram depicting an example of the configuration of an injection molding machine system according to Embodiment 2. The injection molding machine system according to Embodiment 2 is provided with the injection molding machine 1, the information processing apparatus 8, the communication terminal 9 and the notification DB 10 as in Embodiment 1. Note that the control device 6 according to Embodiment 2 is not connected to the communication network. The injection molding machine system according to Embodiment 2 is provided with a machine-side communication terminal 100 for transmitting testification data of the user and machine log data to the information processing apparatus 8. The machine log data is input to the machine-side communication terminal 100 using a portable recording medium A. The machine-side communication terminal 100 performs the processing similar to that by the control device 6 in Embodiment 1 to provide the information processing apparatus 8 with the testification data and the machine log data. The processing details performed on the information processing apparatus 8 side is similar to that of Embodiment 1.

As described above, the injection molding machine system according to Embodiment 2 can create report data regarding a failure in the injection molding machine 1 with sufficient accuracy and uniformity, if trouble occurs in the injection molding machine 1 and notify the serviceperson of the report data as in Embodiment 1.

### Embodiment 3

An injection molding machine system according to Embodiment 3 is different from that in Embodiment 1 in the details of the data to be transmitted by the information processing apparatus 8 to the communication terminal 9. Since the other configurations of the injection molding machine system are similar to those of the system in Embodiment 1, corresponding parts are designated by similar reference codes and detailed description thereof will not be made.

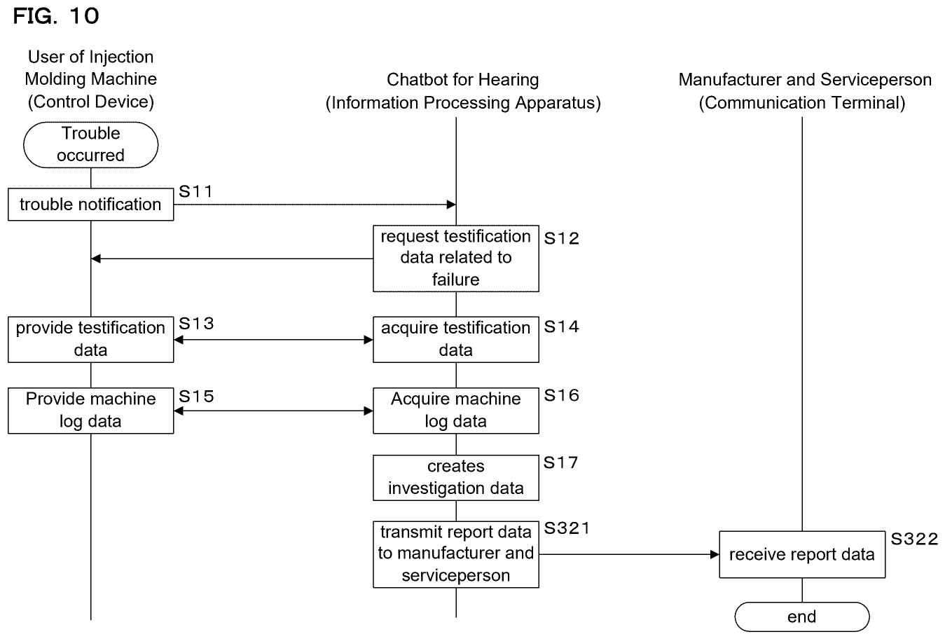

FIG. 10 is a flowchart depicting a report creation processing procedure according to Embodiment 3. The information processing apparatus 8 according to Embodiment 3 transmits investigation data created at step S17 to the communication terminal 9 without executing the processing at steps S18 to S20 in Embodiment 1 (step S321). The communication terminal 9 receives (step S322) and displays the investigation data transmitted from the information processing apparatus 8. The communication terminal 9 can provide a serviceperson with the testification data obtained from the user, the machine log data and the user machine data, though not in the organized format like a report.

As described above, according to the injection molding machine system according to Embodiment 3 can create investigation data regarding a failure in the injection molding machine 1 with sufficient accuracy and uniformity, if trouble occurs in the injection molding machine 1, and notify the serviceperson of the investigation data as in Embodiment 1.

### REFERENCE SIGNS LIST

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds
thereof are therefore intended to be embraced by the claims.

What is claimed is

1. An information processing apparatus comprising:
a processing unit configured to
acquire testification data related to a failure of an injection molding machine through a dialog with a user using a chatbot and machine log data of the injection molding machine in a case where trouble occurs in the injection molding machine; and
create investigation data including the acquired testification data and machine log data; and
a communication unit configured to upload the created investigation data to an external database or notify a person involved in the injection molding machine of the investigation data.

2. The information processing apparatus according to claim 1, wherein the investigation data includes report data in a predetermined format created based on the acquired testification data and machine log data.

3. The information processing apparatus according to claim 2, further comprising a learning model that outputs report data in a predetermined format in a case where a prompt including testification data and machine log data is input, wherein
the processing unit generates the report data by inputting a prompt including the acquired testification data and machine log data to the learning model.

4. The information processing apparatus according to claim 3, wherein the processing unit creates a prompt including the acquired testification data and machine log data, through a dialog with a user using the chatbot.

5. The information processing apparatus according to claim 2, wherein the machine log data includes a machine number of the injection molding machine, and
by referring to a database storing a machine number of the injection molding machine and basic information of a user of the injection molding machine or sales representative information of the injection molding machine in association with each other, the processing unit creates report data including basic information or sales representative information of the user corresponding to a machine number included in the acquired machine log data.

6. The information processing apparatus according to claim 2, wherein
the report data includes an item related to a trouble situation of the injection molding machine, and
the processing unit creates a text describing the trouble situation using the acquired testification data and machine log data.

7. The information processing apparatus according to claim 1, wherein the testification data includes at least one of data indicative of a presence or an absence of power failure, data indicative of an operation status of a peripheral device of the injection molding machine, temperature data and humidity data around the injection molding machine and recovery success data indicative of success or failure of recovery by a restart of the injection molding machine.

8. The information processing apparatus according to claim 1, wherein the machine log data includes time data, data indicative of a process for the injection molding machine at a time indicated by the time data and data indicative of a presence or an absence of trouble.

9. The information processing apparatus according to claim 8, wherein in a case where one process includes multiple stages, the data indicative of the process of the injection molding machine includes data indicative of a stage for each step.

10. The information processing apparatus according to claim 1, wherein the machine log data includes physical quantity data indicative of a condition of the injection molding machine.

11. The information processing apparatus according to claim 1, wherein the machine log data includes a machine number of the injection molding machine, a shot count of the injection molding machine and an error code of trouble occurring in the injection molding machine.

12. The information processing apparatus according to claim 1, wherein the communication unit transmits the investigation data to a communication terminal of a person in charge of maintenance and inspection of the injection molding machine and a communication terminal of a sales office or a quality assurance department in charge of the injection molding machine.

13. An injection molding machine comprising:
a processing unit configured to
acquire testification data related to a failure of the injection molding machine through a dialog with a user using a chatbot and machine log data of the injection molding machine in a case where trouble occurs in the injection molding machine; and
create investigation data including the acquired testification data and machine log data; and
a communication unit configured to upload the created investigation data to an external database or notify a person involved in the injection molding machine of the investigation data.

14. The injection molding machine according to claim 13, wherein the investigation data includes report data in a predetermined format created based on the acquired testification data and machine log data.

15. An information processing method comprising:
acquiring testification data related to a failure of an injection molding machine through a dialog with a user using a chatbot and machine log data of the injection molding machine in a case where trouble occurs in the injection molding machine; and
creating investigation data including the acquired testification data and machine log data, and
uploading the created investigation data to an external database or notifying a person involved in the injection molding machine of the investigation data.

16. The information processing method according to claim 15, wherein
the investigation data includes report data in a predetermined format created based on the acquired testification data and machine log data.

17. A non-transitory computer readable recording medium storing a computer program causing a computer to execute processing of:
acquiring testification data related to a failure of an injection molding machine through a dialog with a user using a chatbot and machine log data of the injection molding machine in a case where trouble occurs in the injection molding machine;
creating investigation data including the acquired testification data and machine log data; and
uploading the created investigation data to an external database or notifying a person involved in the injection molding machine of the investigation data.

18. The non-transitory computer readable recording medium according to claim 17, wherein the investigation data includes report data in a predetermined format created based on the acquired testification data and machine log data.
